(19) United States
(12) Patent Application Publication
(10) Pub. No.: US 2008/0151993 A1
(43) Pub. Date: Jun. 26, 2008

(54) VIDEO SIGNAL PROCESSING APPARATUS, VIDEO SIGNAL PROCESSING METHOD, AND BROADCASTING RECEIVING APPARATUS

(75) Inventor: KOTA MITSUYA, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/954,516

(22) Filed: Dec. 12, 2007

(30) Foreign Application Priority Data
Dec. 26, 2006 (JP) 2006-350016

(51) Int. Cl. H04B 1/66

(52) U.S. Cl. 375/240.01; 375/E07.026

(57) ABSTRACT

According to one embodiment, there is provided a video signal processing apparatus including a determining section which receives a type signal representing whether a video signal is an uncoded video signal or a video signal obtained by decoding a coded digital signal, determines a first threshold (Thₐ, Th_{c}, Thₑ) for determining a density change of the video signal when the type signal represents the uncoded video signal, and determines a second threshold (Th_{b}, Th_{d}, Th_{f}) smaller than the first threshold when the type signal represents the video signal obtained by decoding the coded digital signal, a detecting section which receives the video signal and detects a density change which is smaller than the first threshold or the second threshold determined by the determining section, by using the threshold, and a subtracting section which, when the detecting section detects the density change, subtracts the density change component.

### CROSS-REFERENCE TO RELATED APPLICATIONS

This application is based upon and claims the benefit of priority from Japanese Patent Application No. 2006-350016, filed Dec. 26, 2006, the entire contents of which are incorporated herein by reference.

### BACKGROUND

1. Field

One embodiment of the invention relates to a video signal processing apparatus and a video signal processing method for reducing a video signal, and a broadcasting receiving apparatus using the video signal processing apparatus.

2. Description of the Related Art

In recent years, as to television broadcasting, not only analog broadcasting but also satellite wave and ground wave broadcasting is widely provided and watched. In such digital broadcasting, a broadcasting signal which is received and output by a digital tuner is output as, for example, an MPEG file. For this reason, after this signal is decoded by an MPEG decoder, the decoded signal is used as a video signal. A number of techniques which relate to methods for treating video signals of such digital broadcasting are known.

Patent Document 1 (Jpn. Pat. Appln. KOKAI Publication No. 2004-180248) discloses a technique for determining whether a coding distortion eliminating process is necessary and carrying out block filtration only if necessary in an image coding distortion eliminating method.

The conventional technique in the Patent Document 1 shows a coding distortion in the MPEG decoder, but does not disclose a technique for executing a video process on a video signal from the MPEG decoder and an uncoded video signal in different manners.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating one example of a constitution of a horizontal-direction coring section according to one embodiment of the present invention;

FIG. 2 is a block diagram illustrating one example of a constitution of a vertical-direction coring section according to one embodiment of the present invention;

FIG. 3 is a block diagram illustrating one example of a constitution of a time axis noise eliminating section according to one embodiment of the present invention;

FIG. 4 is a block diagram illustrating one example of a constitution of an image quality processing section including the coring sections and enhancer sections according to one embodiment of the present invention;

FIG. 5 is a block diagram illustrating one example of a constitution of a broadcasting receiving apparatus according to one embodiment of the present invention;

FIG. 6 is a flowchart illustrating one example of a coring process in a horizontal direction in the broadcasting receiving apparatus according to one embodiment of the present invention;

FIG. 7 is a flowchart illustrating one example of the coring process in a vertical direction in the broadcasting receiving apparatus according to one embodiment of the present invention; and

FIG. 8 is a flowchart illustrating one example of a process in a time axial direction in the broadcasting receiving apparatus according to one embodiment of the present invention.

### DETAILED DESCRIPTION

Various embodiments according to the invention will be described hereinafter with reference to the accompanying drawings. In general, according to one embodiment of the invention, a video signal processing apparatus comprising: a determining section which receives a type signal representing whether a video signal is an uncoded video signal or a video signal obtained by decoding a coded digital signal, determines a first threshold for determining a density change of the video signal when the type signal represents the uncoded video signal, and determines a second threshold smaller than the first threshold when the type signal represents the video signal obtained by decoding the coded digital signal; a detecting section which receives the video signal and detects a density change which is smaller than the first threshold or the second threshold determined by the determining section, by using the threshold; and a subtracting section which, when the detecting section detects the density change, subtracts the density change component.

One embodiment of the present invention provides a video signal processing apparatus and a video signal processing method which execute different video processes on an uncoded video signal and a decoded video signal from a digital tuner, and a broadcasting receiving apparatus.

One embodiment for achieving the object is a video signal processing apparatus comprising:

a determining section (11, 14, 17) which receives a type signal (d₂) representing whether a video signal (d₁) is an uncoded video signal or a video signal obtained by decoding a coded digital signal, determines a first threshold (Thₐ, Th_{c}) for determining a density change of the video signal when the type signal represents the uncoded video signal, and determines a second threshold (Th_{b}, Th_{d}, Th_{f}) smaller than the first threshold when the type signal represents the video signal obtained by decoding the coded digital signal;

a detecting section (12, 15, 18) which receives the video signal and detects a density change which is smaller than the first threshold or the second threshold determined by the determining section, by using the threshold; and

a subtracting section (13, 16, 19) which, when the detecting section detects the density change, subtracts the density change component.

As a result, since a noise of a video signal coded by a decoder is reduced by the decoder, the noise which is not more than a small threshold Thₐ is corrected to a small level. Since noise remains in the uncoded video signal, this noise which is not more than a large threshold Th_{b} is corrected to a large level.

The embodiment of the present invention will be described in detail below with reference to the drawings.

<One Example of Video Processing Apparatus According to One Embodiment of the Present Invention>

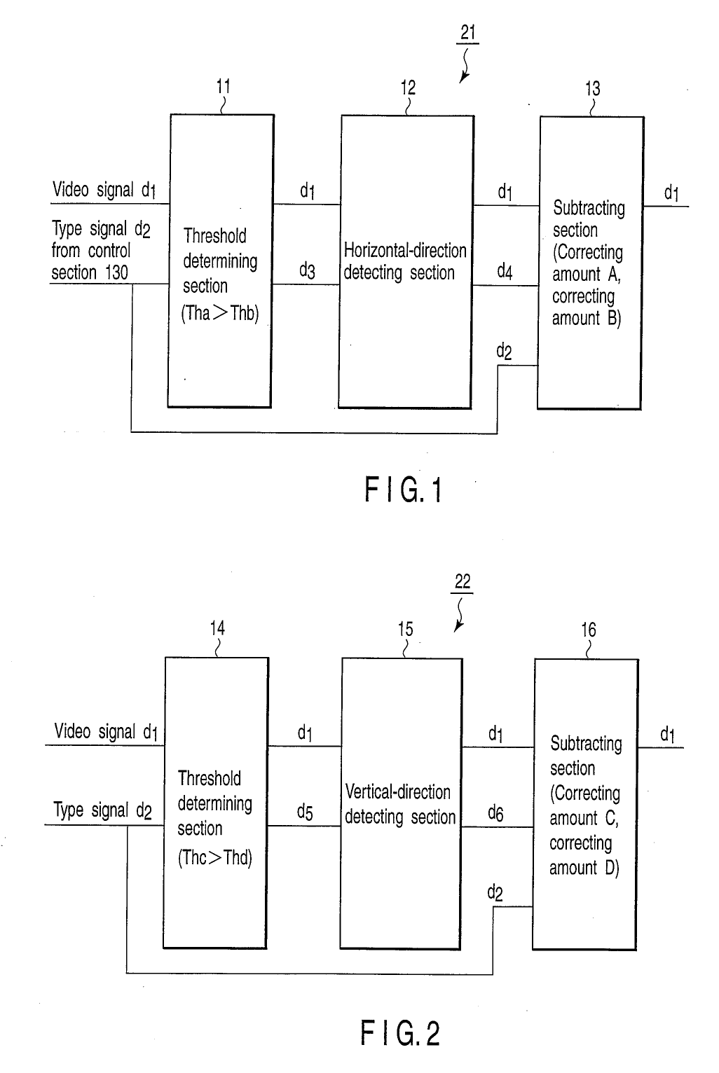

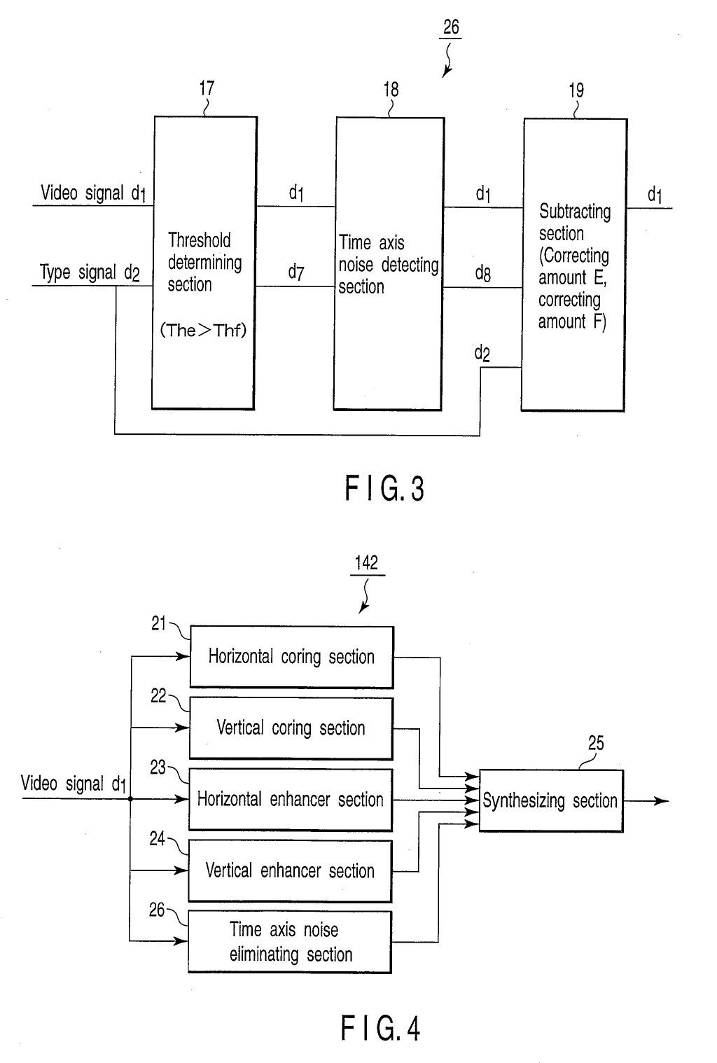

The video processing apparatus according to one embodiment of the present invention will be described in detail below with reference to the drawings. FIG. 1 is a block diagram illustrating one example of a constitution of a horizontal-direction coring section according to one embodiment of the present invention. FIG. 2 is a block diagram illustrating one example of a constitution of a vertical-direction coring section according to one embodiment of the present invention. FIG. 3 is a block diagram illustrating one example of a constitution of a time axis noise eliminating section according to one embodiment of the present invention. FIG. 4 is a block diagram illustrating one example of a constitution of the image quality processing section including the coring sections and the enhancer sections according to one embodiment of the present invention.

The video processing apparatus according to one embodiment of the present invention is a video processing apparatus 142 including a horizontal-direction coring section 21 shown in FIG. 1, a vertical-direction coring section 22 shown in FIG. 2, and a time axis noise eliminating section shown in FIG. 3. FIG. 4 illustrates one example of the constitution.

As shown in FIG. 4, the video processing apparatus 142 has the horizontal coring section 21, the vertical coring section 22, a horizontal enhancer section 23, a vertical enhancer section 24, a time axis noise eliminating section 26, and a synthesizing section 25. The horizontal coring section 21 corrects a density change in a horizontal direction. The vertical coring section 22 corrects a density change in a vertical direction. The horizontal enhancer section 23 enhances an edge in the horizontal direction. The vertical enhancer section 24 enhances an edge in the vertical direction. The time axis noise eliminating section 26 corrects a noise in a time axial direction. The synthesizing section 25 synthesizes video outputs from these section.

As shown in FIG. 1, the horizontal direction coring section 21 included in the video processing apparatus 142 has a threshold determining section 11, a horizontal direction detecting section 12, and a subtracting section 13. The threshold determining section 11 receives a type signal d₂ from a control section 130. The horizontal direction detecting section 12 receives a video signal d₁ and a threshold signal d₃ via a data bus. The subtracting section 13 receives a video signal d₁, a detection signal d₄ and the type signal d₂ via the data bus.

As shown in FIG. 2, the vertical direction coring section 22 included in the video processing apparatus 142 has a threshold determining section 14, a vertical direction detecting section 15 and a subtracting section 16. The threshold determining section 14 receives a type signal d₂ from the control section 130. The vertical direction detecting section 15 receives a video signal d₁ and a threshold signal d₅ via the data bus. The subtracting section 16 receives the video signal d₁, a detection signal d₆ and the type signal d₂ via the data bus.

The time axis noise eliminating section 26 included in the video processing apparatus 142 has, as shown in FIG. 4, a threshold determining section 17, a time axis noise detecting section 18, and a subtracting section 19. The threshold determining section 17 receives a type signal d₂ from the control section 130. The time axis noise detecting section 18 receives a video signal d₁ and a threshold signal d₇ via the data bus. The subtracting section 19 receives the video signal d₁, a detection signal d₈ and the type signal d₂ via the data bus.

Detailed operations of the horizontal coring section 21, the vertical coring section 22, the horizontal enhancer section 23, the vertical enhancer section 24 and the time axis noise eliminating section 26 will be described later with reference to the flowcharts.

(Constitution and Operation of Broadcasting Receiving Apparatus)

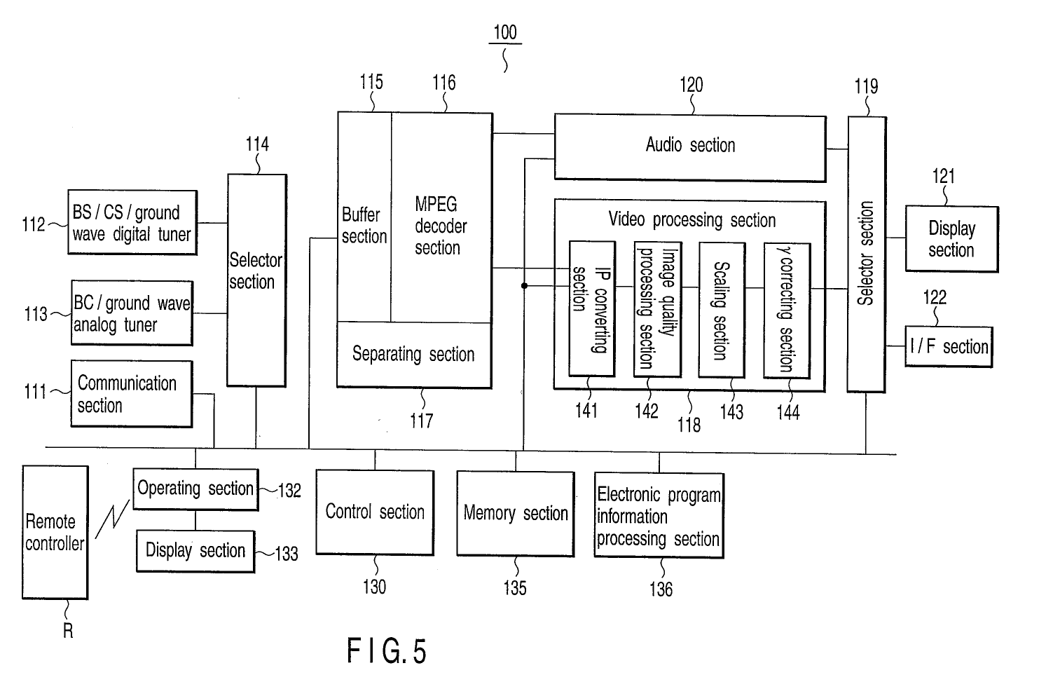

A constitution and an operation of a broadcasting receiving apparatus as one example of the apparatus to which the video processing apparatus 142 is applied will be described with reference to FIG. 5. FIG. 5 is a block diagram illustrating one example of the constitution of the broadcasting receiving apparatus according to one embodiment of the present invention. The broadcasting receiving apparatus 100 is a television apparatus as shown in FIG. 5, and the control section 130 is connected to respective sections via the data bus in order to control the entire operation.

The broadcasting receiving apparatus 100 in FIG. 5 has an MPEG decoder section 116 composing a reproduction side, and the control section 130 which controls the operation of the apparatus main body as main components. The broadcasting receiving apparatus 100 has an input side selector 114 and an output side selector 119. The input side selector 114 is connected to a communication section 111 having LAN and a mail function, a BS/CS/ground wave digital tuner section 112, and a BS/ground wave analog tuner section 113.

The broadcasting receiving apparatus 100 has an MPEG decoder section 116, a separating section 117, a memory section 135 and an electronic program information processing section 136. The memory section 135 suitably records video information from the tuner sections. The electronic program information processing section 136 acquires electronic program information from a broadcasting signal so as to display the information on a screen. These sections are connected to the control section 130 via the data bus. An output from the selector section 119 is connected to a display section 121, and is supplied to an external apparatus via an interface section 122 for communication with the external apparatus.

The broadcasting receiving apparatus 100 is connected to the control section 130 via the data bus, and has an operating section 132 which receives user's operations and operations of a remote controller R. The remote controller R enables the operations approximately equivalent to those of the operating section 132 provided to the main body of the broadcasting receiving apparatus 100, namely, enables various settings such as the operations of the tuners.

In the broadcasting receiving apparatus 100, a broadcasting signal is input from an reception antenna into the tuners 112 and 113, where a channel selection is made. The selected video/audio signal is decoded by the MPEG decoder section 116 so as to be supplied to the video processing section 118. The video processing section 118 has an IP converting section 141, an image quality processing section 142, a scaling section 143 and a γ correcting section 144. The IP converting section 141 converts an interlace signal into a progressive signal. The image quality processing section 142 executes a coring process and an enhancing process detailed in FIGS. 1 to 3. The scaling section 143 executes a scaling process. The γ correcting section 144 makes a γ correction on a video signal.

These input signals are managed by the control section 130, and are switched into signals to be input into the video processing section 118. An operation signal from the remote controller R is supplied to the control section 130 via the operating section 132 in order to make the channel selection and input conversion. As a result, the MPEG decoder section 116 and the video processing section 118 are controlled. The video signal processed by the video processing section 118 is displayed on the display section 121 via the selector section 119. The audio signal is supplied to a speaker, not shown.

(Coring Processes in Horizontal and Vertical Directions)

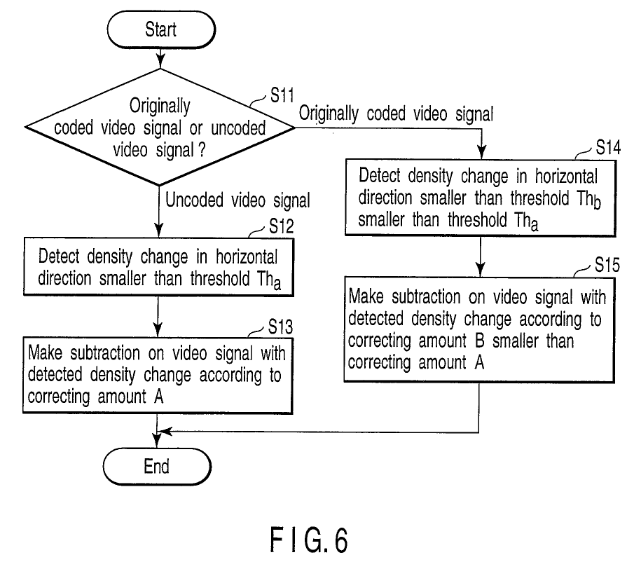

The coring processes in the horizontal and vertical directions in the image quality processing section 142 in FIGS. 1 to 3 and 5 will be described in detail below with reference to the flowchart of FIGS. 5 and 6.

FIG. 5 is a flowchart illustrating one example of the coring process in the horizontal direction in the broadcasting receiving apparatus according to one embodiment of the present invention. FIG. 6 is a flowchart illustrating one example of the coring process in the vertical direction. The respective steps in the flowcharts of FIGS. 5 and 6 can be replaced by circuit blocks, and thus all the steps in the flowcharts can be redefined as blocks.

That is to say, the functions of the horizontal coring section 21 and the vertical coring section 22 can be realized by synthesizing circuit configurations having the following functions or can be suitably realized by a microcomputer and programs.

The horizontal coring section 21 shown in FIG. 1 detects particularly a noise (specifically, a density change) in the horizontal direction of a supplied video signal d₁, and suitably subtracts the noise so as to eliminate the noise. Specifically, the horizontal coring section 21 detects a disturbance of a video appearing on a texture such as a wall in the horizontal direction in the case of the video in a room during program broadcasting, and automatically corrects this into a smooth video. The vertical coring section 22 similarly detects a disturbance of a video appearing on the texture such as a wall in a vertical direction, and automatically converts this into a smooth video. The time axial direction noise eliminating section 26 similarly detects a disturbance of a video appearing on the texture such as a wall in the time axial direction, and automatically corrects it into a smooth video.

Horizontal Coring Process

As shown in the flowchart of FIG. 5, the horizontal coring section 21 determines whether the video signal d₁ supplied from the threshold determining section 11 is an uncoded video signal (as one example, a video signal output from the analog tuner section 113) or an originally coded video signal (as one example, a video signal obtained by decoding a digital signal from the digital tuner section 112) based on a type signal d₂ supplied from the control section 130 (step S11).

The uncoded video signal includes not only the video signal output from the analog tuner section 113 but also an analog video signal supplied from a video apparatus such as a video recorder analog-connected from the outside, and a video signal of an uncompressed type external DVD player digital-connected.

The originally coded video signal includes not only the video signal output from the digital tuner section 112 and decoded by the decoder but also a video signal obtained by decoding a coded video signal supplied from the external video apparatus by a decoder.

That is to say, when the threshold determining section 11 determines that the video signal d₁ is the uncoded video signal based on the type signal d₂, it supplies a threshold signal d₃ to the horizontal-direction detecting section 12. When the horizontal-direction detecting section 12 detects a density change in the horizontal direction smaller than a threshold Thₐ from the video signal d₁ based on the threshold Thₐ (>Th_{b}) by means of a threshold signal d₃, it supplies a detection signal d₄ to the subtracting section 13 (step S12).

The subtracting section 13 subtracts a density change component detected based on the detection signal d₄, so as to eliminate a noise component from the video. A correcting amount at this time is determined by the subtracting section 13 based on the type signal d₂. When the type signal d₂ shows that the video signal d₁ is an uncoded video signal, the subtracting process is executed on the video signal according to the correcting amount A (step S13).

As a result, when the video signal d₁ is an uncoded video signal, a larger quantity of noise remains in comparison with an original digital video. For this reason, the subtracting process is executed on the noise detected by means of the larger threshold Th_{b} according to the large correcting amount A (>correcting amount B).

Similarly, in Step S11, when the threshold determining section 11 determines that the video signal d₁ is an originally coded video signal based on the type signal d₂, it supplies a threshold signal d₃ to the horizontal-direction detecting section 12. When the horizontal-direction detecting section 12 detects a density change in the horizontal direction smaller than the threshold Th_{b} from the video signal d₁ based on the threshold Th_{b} (<Thₐ) by means of the threshold signal d₃, it supplies a detection signal d₄ to the subtracting section 13 (step S14).

The subtracting section 13 subtracts the density change component detected based on the detection signal d₄, so as to eliminate a noise component from the video. The correcting amount at this time is determined by the subtracting section 13 based on the type signal d₂. When the type signal d₂ shows that the video signal d₁ is an original coded video signal, the subtracting process is executed on the video signal according to the correcting amount B (<correcting amount A) (step S15).

As a result, when the video signal d₁ is the originally coded video signal, noise has already been eliminated by the decoder section 116 to a certain extent at the time of DA conversion. For this reason, this video signal includes comparatively less noise than noise in the uncoded video signal, and thus the noise detected based on the small threshold Th_{b} is subtracted according to the small correcting amount B (<correcting amount A).

In this embodiment, a discrimination is made whether the video signal is an originally coded video signal, a video signal with less noise DA-converted by the decoder section 116 or an uncoded video signal with comparatively larger noise. The threshold for detecting noise (density change) and the correcting amount of the subtracting process are changed. As a result, a suitable image quality process can be executed according to characteristics of video signals.

Vertical Coring Process

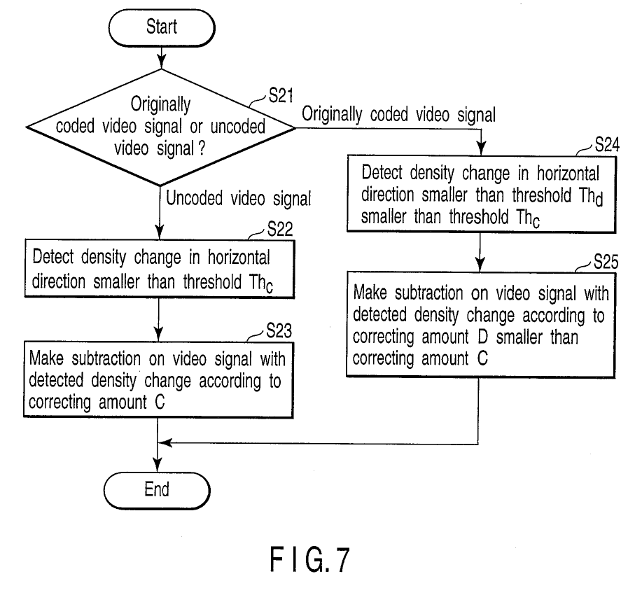

Since the process from step S21 to step S25 shown in the flowchart of FIG. 7 produces the same effect as that of the process from step S11 to step S15 shown in the flowchart of FIG. 6, the description thereof is omitted. In the flowchart of FIG. 7, the detection of a density change at steps S22 and S24 is the detection of a density change in the vertical direction (not in the horizontal direction).

A relationship: Thₐ>Th_{b} holds for the threshold at the time of the horizontal coring process, but a relationship: Th_{c}>Th_{d} holds for the threshold of the vertical coring process. A relationship: correcting amount A>correcting amount B holds in the horizontal coring process, but a relationship: correcting amount C>correcting amount D holds in the vertical coring process.

In the case of the vertical coring process, a discrimination is made whether the video signal is an originally coded video signal, a video signal with less noise DA-converted by the decoder section 116 or an uncoded video signal with comparatively large noise. The threshold for detecting noise (density change) and the correcting amount of the subtracting process are changed, thereby enabling the suitable image quality process according to characteristics of video signals.

Time Axis Noise Eliminating Process

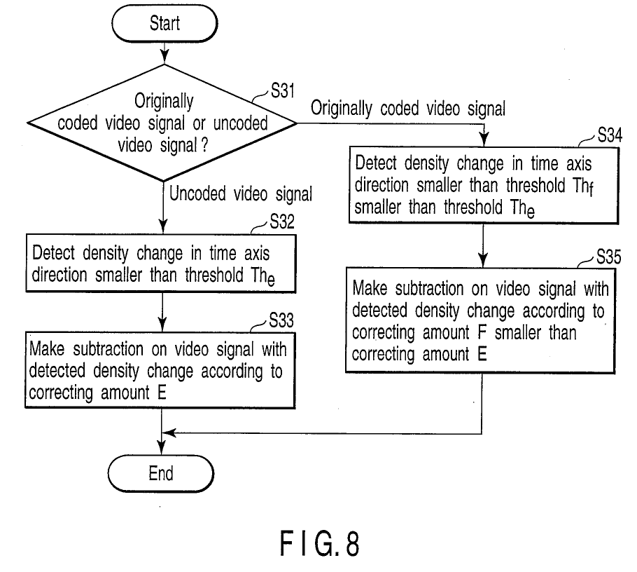

Since the process from step S31 to step S35 shown in the flowchart of FIG. 8 produces the same effect as that in the process from step S11 to step S15 shown in the flowchart of FIG. 6, the description thereof is omitted. In the flowchart of FIG. 8, the detection of the density change at steps S32 and S34 is the detection of the density change in the time axis direction (not in the horizontal direction).

The relationship: Thₐ>Th_{b} holds for the threshold at the time of the horizontal coring process, but a relationship: Thₑ>Th_{f} holds for the threshold in the time axis noise eliminating process. The relationship: correcting amount A>correcting amount B holds in the horizontal coring process, but a relationship: correcting amount E>correcting amount F holds in the time axis noise eliminating process.

In the case of the time axis noise eliminating process, a discrimination is made whether the video signal is an originally coded video signal, a video signal with less noise DA-converted by the decoder section 116, or an uncoded video signal with comparatively large noise. The threshold for detecting noise (density change) and the correcting amount of the subtracting process are changed, thereby enabling the suitable image quality process according to characteristics of the video signals.

### ANOTHER EMBODIMENT

In the case where the video signals recorded in the memory section 135 are subject to the coring process and the noise eliminating process, it is desirable that the control section 130 generates and manages type information at the time of recording. That is to say, it is desirable that type information which represents that the video signal is an uncoded video signal or an originally coded video signal is attached to management information for the recording process of the video signals generated by the control section 130 so as to be managed in a memory area or the like.

When the video signals are managed in such a manner, the control section 130 generates the type signal d₂ at the time of reproduction based on type information which represents whether the stored video signal is an uncoded video signal or an originally coded video signal so as to supply the type signal d₂ to the coring sections 21 and 22. As a result, the video signal recorded in the memory section 135 can be processed according to the type of the video signal similarly to a real-time video signal.

A person skilled in the art can realize the present invention by the above various embodiments, and easily conceives of various modified examples of these embodiments, and can apply the present invention to various embodiments without inventive ability. The present invention, therefore, covers a wide range which does not conflict with the disclosed principle and new characteristics, and thus is not limited to the above embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing apparatus comprising:
a determining section which receives a type signal representing whether a video signal is an uncoded video signal or a video signal obtained by decoding a coded digital signal, determines a first threshold for determining a density change of the video signal when the type signal represents the uncoded video signal, and determines a second threshold smaller than the first threshold when the type signal represents the video signal obtained by decoding the coded digital signal;
a detecting section which receives the video signal and detects a density change which is smaller than the first threshold or the second threshold determined by the determining section, by using the threshold; and
a subtracting section which, when the detecting section detects the density change, subtracts the density change component.

2. The video signal processing apparatus according to claim 1, wherein when the type signal determines that the video signal is the uncoded video signal, the subtracting section subtracts the density change of the video signal by a first correcting amount, and when the type signal determines that the video signal is the video signal obtained by decoding the coded digital signal, subtracts the density change by a second correcting amount smaller than the first correcting amount.

3. The video signal processing apparatus according to claim 1, wherein the detecting section receives the video signal and detects a density change in a horizontal direction smaller than the first threshold or the second threshold supplied from a supply section, by using the threshold.

4. The video signal processing apparatus according to claim 1, wherein the detecting section receives the video signal and detects a density change in a vertical direction smaller than the first threshold or the second threshold supplied from a supply section, by using the threshold.

5. The video signal processing apparatus according to claim 1, wherein the detecting section receives the video signal and detects a density change in a time axis direction smaller than the first threshold or the second threshold supplied from a supply section, by using the threshold.

6. A broadcasting receiving apparatus comprising:
an analog tuner section which receives an analog broadcasting signal and supplies an uncoded video signal;
a digital tuner section which receives a digital broadcasting signal so as to output a coded digital signal;
a decoder section which decodes the coded digital signal so as to output a video signal;
a control section which generates and outputs a type signal which represents whether the video signal is an uncoded video signal or a video signal obtained by decoding the coded digital signal;
a determining section which receives the type signal from the control section, determines a first threshold for determining a density change of the video signal when the type signal represents the uncoded video signal, and determines a second threshold smaller than the first threshold when the type signal represents the video signal obtained by decoding the coded digital signal;
a detecting section which receives the video signal and detects a density change which is smaller than the first threshold or the second threshold determined by the determining section, by using the threshold;
a subtracting section which, when the detecting section detects the density change, subtracts the density change component; and
a display section which displays a video on a screen based on the video signal from which the density change component is subtracted by the subtracting section.

7. A video signal processing method comprising:
receiving a type signal which represents whether a video signal is an uncoded video signal or a video signal obtained by decoding a coded digital signal;
determining a first threshold for determining a density change of the video signal when the type signal represents the uncoded video signal;
determining a second threshold smaller than the first threshold when the type signal represents the video signal obtained by decoding the coded digital signal;
receiving the video signal so as to detect a density change smaller than the first threshold or the second threshold, by using the threshold; and
when the density change is detected, subtracting the density change component.

8. The video signal processing method according to claim 7, wherein when the type signal determines that the video signal is the uncoded video signal, the density change of the video signal is subtracted by a first correcting amount, and when the type signal determines that the video signal is the video signal obtained by decoding the coded digital signal, the density change is subtracted by a second correcting amount smaller than the first correcting amount.

9. The video signal processing method according to claim 7, wherein the video signal is received, and a density change in a horizontal direction smaller than the first threshold or the second threshold is detected, by using the threshold.

10. The video signal processing method according to claim 7, wherein the video signal is received, and a density change in a vertical direction smaller than the first threshold or the second threshold is detected, by using the threshold.
